(19) United States
(12) Patent Application Publication
(10) Pub. No.: US 2021/0342196 A1
(43) Pub. Date: Nov. 4, 2021

(54) MULTIPLE CUSTOMER ENVIRONMENT MANAGEMENT IN A CLOUD SERVICES PLATFORM

(71) Applicant: Microsoft Technology Licensing, LLC, Redmond, WA (US)

(72) Inventors: Poornima Natarajan, Redmond, WA (US); Dasaradha Ramu Yalamanchili, Bothell, WA (US); Niraj Girishkumar Gandhi, Bothell, WA (US); Mutlu Kurtoglu, Redmond, WA (US); Mark Eugene Russinovich, Bellevue, WA (US); Vladimir Joanovic, Seattle, WA (US); Kristopher A. Bash, Seattle, WA (US); Archana Balakrishnan, Sharon, MA (US); Kristian Nese, Knarvik (NO); Stuart L. S. Kwan, Redmond, WA (US); Raju Charu Vikram Kakumani, Redmond, WA (US)

(21) Appl. No.: 16/892,814

(22) Filed: Jun. 4, 2020

(30) Foreign Application Priority Data
Apr. 30, 2020 (IN) 202041018581

(51) Int. Cl. G06F 9/50; G06F 11/34; H04L 29/06; H04L 12/24

(52) U.S. Cl. CPC G06F 9/5072; G06F 9/5077; H04L 41/0843; G06F 11/3476; H04L 63/0807; G06F 9/5005

(57) ABSTRACT

Methods, systems, apparatuses, and computer program products are described herein that enable a service provider to manage cloud resources deployed to different customer environments, residing in different tenants of a cloud services platform using a single access token. The service provider publishes templates that specify service provider permissions with respect to cloud resource deployments. By deploying such a template, a customer authorizes the service provider to manage cloud resources deployed to the customer's environment. In particular, the deployment causes an access token granted to the service provider to be associated with the customer cloud resources. When the service provider logs into his environment, the access token is provided to the cloud resource manager. Based at least on the service provider identifier included in the access token, the cloud resource manager logically projects to the service provider's environment the customer cloud resources that the service provider is permitted to manage.

### CROSS-REFERENCE TO RELATED APPLICATIONS

This application claims priority to Indian Provisional Patent Application No. 202041018581, filed Apr. 30, 2020, the entirety of which is incorporated by reference herein.

### BACKGROUND

Cloud computing is a type of Internet-based computing that provides shared computer processing resources and data to computers and other devices on demand. It is a model for enabling ubiquitous, on-demand access to a shared pool of configurable computing resources (e.g., computer networks, servers, storage) and applications and services built thereon, which can be rapidly provisioned and released with minimal management effort. Cloud computing and storage solutions provide users and enterprises with various capabilities to store and process their data in third-party data centers that may be located far from the user—ranging in distance from across a city to across the world. Like a utility (e.g., an electrical grid), cloud computing relies on the sharing of resources to achieve coherence and economy of scale.

As organizations both big and small are extending their information technology (IT) capabilities, they are adopting cloud environments for hosting their line-of-business applications to take advantage of the scalability, flexibility and economies of scale that the cloud offers. With this change, these organizations are faced with challenges of limited cloud-based skills for managing their IT estates in the cloud, while their volume of business-critical applications is increasing. This introduces complexity and the need for more automation. Managed service providers (managing partners) and application builder independent software vendors (ISVs) help organizations address these challenges by managing the organization's IT estate on their behalf. Enabling authorization for service providers or central IT governance users within an enterprise to operate an organization's resources is fundamental for management of applications at scale with automation scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer program products are described herein that enable a service provider to manage cloud resources deployed to different customer environments in different cloud tenants of a cloud services platform using a single access token. The service provider publishes one or more management templates that each specify service provider permissions with respect to cloud resource deployments. Customers authorize the service provider to manage the customers' cloud resources by deploying a management template. When the management template is deployed by a particular customer, a cloud resource manager associates the customer's environment with the service provider's environment, along with the various permissions granted to the service provider for that customer's environment residing in a different cloud tenant from that of the service provider. When the service provider logs into his/her service provider environment, the access token granted to the service provider is provided to the cloud resource manager. The cloud resource manager obtains the identifier of the service provider from the access token and determines the customer environments (and permissions therefor) that are associated with the service provider. Subsequently, the cloud resource manager logically projects to the service provider's environment each of the customers' cloud resources that the service provider is permitted to manage (i.e., the cloud resource manager allows cross-tenant access). Such techniques enable the service provider to use a single secure token to sign-in to their own environment or interface to obtain access to all the assets managed thereby together in a single, aggregated and centralized view, allowing them to perform tasks or operations in a cross-tenant fashion) at scale without having to individually log in to each customer environment residing in a different cloud tenant.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the application and, together with the description, further explain the principles of the embodiments and to enable a person skilled in the relevant art(s) to make and use the embodiments.

FIG. 1 is a block diagram of an example cloud services platform upon which embodiments may be implemented.

FIG. 2 is a block diagram that illustrates the use of templates to deploy a cloud service within the cloud services platform of FIG. 1.

FIG. 3 is a block diagram of an example cloud services platform that is configured to support the management of cloud resources by a service provider in accordance with an example embodiment.

FIG. 4 is a block diagram of a system that illustrates a deployment of management templates to different customer environments that enables a service provider to manage the customer environments in accordance with an example embodiment.

FIG. 5 shows a flowchart of a method for enabling a service provider to manage a customer environment in accordance with an example embodiment.

FIG. 6 is a block diagram of a system for enabling a service provider to manage a first customer environment in accordance with an example embodiment.

FIG. 7 shows a flowchart of a method for enabling the service provider to manage a second customer environment in accordance with an example embodiment.

FIG. 8 is an example user interface screen displaying a service provider environment in accordance with an example embodiment.

FIG. 9 shows a flowchart of a method for performing an action with respect to a plurality of resources at scale in accordance with an example embodiment.

FIG. 10 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Embodiments described herein are directed to enabling a service provider to manage cloud resources deployed to different customer environments in different cloud tenants of a cloud services platform using a single access token. Each of the multiple customer environments and the service provider environment are managed in a different environment of the cloud services platform (e.g., they are managed as different tenants). The service provider publishes one or more management templates that each specify service provider permissions with respect to cloud resource deployments. Customers authorize the service provider to manage the customers' cloud resources by deploying a management template. When the management template is deployed by a particular customer, a cloud resource manager associates the customer's environment with the service provider's environment, along with the various permissions granted to the service provider for that customer's environment residing in a different cloud tenant from that of the service provider. When the service provider logs into his/her service provider environment, the access token granted to the service provider is provided to the cloud resource manager. The cloud resource manager obtains the identifier of the service provider from the access token and determines the customer environments (and permissions therefor) that are associated with the service provider. Subsequently, the cloud resource manager logically projects to the service provider's environment each of the customers' cloud resources that the service provider is permitted to manage (i.e., the cloud resource manager allows cross-tenant access). Such techniques enable the service provider to use a single secure token to sign-in to their own environment or interface to obtain access to all the assets managed thereby together in a single, aggregated and centralized view, allowing them to perform tasks or operations in a cross-tenant fashion) at scale without having to individually log in to each customer environment.

Today, service providers are challenged with the back-and-forth nature of discovery, negotiation and setup of least-privilege roles and authorization in the IT environments of the organizations they manage. Service providers require a consistent and sufficiently precise identity access approach that removes friction and enables them to perform operations on behalf of organizations they manage with precise access settings, thereby reducing the security, governance, and audit risk of both the service provider and the end-user organization, while meeting compliance and governance requirements of both the parties.

Traditionally, service providers obtain access to the environments of these organizations through multiple ways depending on the organization's unique identity requirements. One model for providing access is by the organization explicitly issuing user credentials for access to their environment for the service provider. Another model for providing access is by the organization adding the service provider directly as a user to the organization's IT environment with full access permissions (i.e., either all or nothing).

Both models have scale limitations and do not enable concurrent cross-environment (e.g., cross-tenant) management capabilities in the scenarios in which service providers manage the IT estates of multiple organizations or environments of multiple business functions. As service providers operate hundreds, if not thousands, of organizations' IT environments and need to perform common management scenarios (such as performance, security, monitoring or patch management) across these environments, performing these operations becomes very cumbersome, as these operations are performed one-by-one per IT environment.

The techniques described herein address the needs of the growing community of service providers. In this model, organizations can explicitly grant a service provider precise access to their cloud resources, such as servers, networks, Internet-of-Things (IoT) edge devices, etc., for specific roles or functions such as creating, updating, and deleting logical assets, or simply viewing and monitoring the health of the assets, the governance and compliance or security posture across all the organizations' IT assets. The resources of multiple organizations are logically projected into the environment of the managing service provider, which enables management-at-scale for service providers, from a single control and command interface, which simplifies and makes automatable both the access specifications and granting permissions aspect of authorization. With logical resource projection, a single managing user can access the assets of all IT environments of the organizations they manage via a single access token. In addition, service providers can take one action across all environments across all their end-customers, in a one-to-many fashion using that single token.

Traditionally, service providers needed to be explicitly added to each environment being managed, introducing complexity in managing credentials of these providers on an on-going basis. This approach introduces security risks in the scenario where a user leaving the service provider organization could continue to retain access to a managed organization's environment (with potential access to their data as well), if the service provider inadvertently neglects to remove access from one or more of the multiple environments they typically manage at a time. Furthermore, it requires logging into each of the environments at a time (i.e., the use of multiple tokens or sign-ins to access and perform on-going tasks in these environments). This also requires service providers to manage authentication credentials. As such, the complexity grows with growth of the IT environments being managed, thereby introducing complexity on operations for service providers on top of their core business skills. As described herein, the logical resource projection techniques provide the ability to perform operations, such as monitoring the health of servers or running an automation script to patch servers across all the environments through a single operation, across many resources of many end-users, instead of performing them individually in each environment.

Moreover, the logical projection techniques described herein enable an organization providing access to their environment to a service provider to have complete control of the explicit granular access granted for an asset scope and role type, such as read and/or write access. These permissions can be provided by a service provider via a management template published on a public marketplace for organizations to accept and start consuming. This provides service providers the advantage of expanding their market and essentially makes it a one-click operation for organizations to approve authorization, thereby eliminating cumbersome on-boarding processes that are conventionally used.

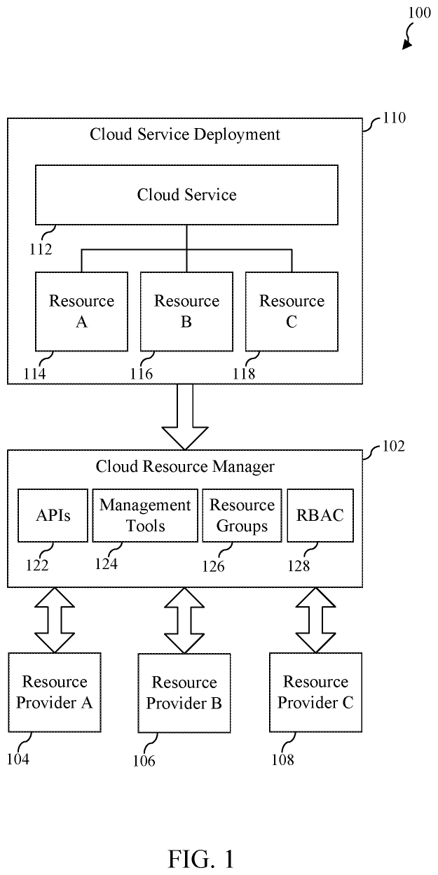

FIG. 1 is a block diagram of an example cloud services platform 100 upon which embodiments described herein may be implemented. In accordance with at least one embodiment, cloud services platform 100 comprises part of the Microsoft® Azure® cloud computing platform, owned by Microsoft Corporation of Redmond, Wash., although this is only an example and not intended to be limiting. As shown in FIG. 1, cloud services platform 100 includes a cloud resource manager 102, a plurality of resource providers including a resource provider A 104, a resource provider B 106, and a resource provider C 108, and a cloud service deployment 110. Each of these components will now be described.

Cloud resource manager 102 comprises a collection (or “framework”) of software-based tools and/or services that can be invoked programmatically or by a user to deploy, update, or delete resources that are themselves utilized to support a cloud service deployment. As used herein the term “cloud service deployment” generally refers to any application or service that is deployed on or otherwise implemented by a cloud infrastructure and includes but is not limited to both Platform as a Service (PaaS) applications and Software as a Service (SaaS) applications. In FIG. 1, cloud resource manager 102 has deployed exemplary cloud service deployment 110. In one embodiment, cloud resource manager 102 comprises the Microsoft® Azure® Resource Manager, although this is only an example and is not intended to be limiting. As used herein, the term “cloud service vendor” or “vendor” is used to broadly refer to any entity that is capable of providing a cloud service (e.g., a PaaS or SaaS application), and may include persons and/or organizations. As used herein, the term “cloud service customer” or “customer” is used to broadly refer to any consumer of a cloud service, and may include persons and/or organizations. A vendor and/or a customer may be the same entity that provides cloud services platform 100, may be employed by or affiliated with such entity, or may be a different entity entirely (e.g., a third party) with respect thereto.

As further shown in FIG. 1, cloud service deployment 110 includes a cloud service 112 that is configured to utilize a plurality of cloud resources including a resource A 114, a resource B 116, and a resource C 118. As used herein, the term “cloud resource” or “resource” broadly refers to any deployable and/or manageable item that is made available via a cloud services platform such as cloud services platform 100. A resource may comprise, for example and without limitation, a virtual machine, a storage account, a Web application, a database, or a virtual network. Persons skilled in the relevant art(s) will appreciate that a wide variety of other resource types may be made available by cloud services platform 100. Such resources can be used to implement cloud services such as cloud service 112.

In cloud services platform 100, the resources that are used to support a given cloud service deployment are programmatically allocated or provided by a corresponding resource provider. The resource provider may also facilitate monitoring and management of a resource after it is allocated. For example, as will be described below, the resources may be enabled to be managed by a service provider. As used herein, the term “service provider” is used to broadly refer to any entity that is capable of managing cloud resources on behalf a customer which can be divisions or subsidiaries of a single organization residing on different cloud tenants. The service provider may comprise any number of personnel, systems and/or devices, each having particular roles and/or permissions with respect to cloud resources associated with particular customer. A service provider may be the same entity that provides cloud services platform 100, may be employed by or affiliated with such entity, or may be a different entity entirely (e.g., a third party) with respect thereto.

In the example shown in FIG. 1, cloud resource manager 102 is operable to invoke resource provider A 104 to provide resource A 114, to invoke resource provider B 106 to provide resource B 116, and to invoke resource provider C 108 to provide resource C 118. To facilitate interaction between cloud resource manager 102 and the resource providers, each resource provider is registered with cloud resource manager 102 and establishes a resource provider contract (RPC) therewith (e.g., a Hypertext Transfer Protocol Secure (HTTPS) Representational State Transfer (REST) API contract, although this is only an example). Non-limiting examples of resource providers within the Microsoft® Azure® cloud services platform include Microsoft. Compute, which can provide a virtual machine resource, Microsoft.Storage, which can provide a storage account resource, and Microsoft.Web, which can provide resources related to Web applications.

Cloud resource manager 102 comprises several features that further facilitate the deployment, management and monitoring of resources for cloud service deployments. For example, as shown in FIG. 1, cloud resource manager 102 exposes a set of APIs 122. APIs 122 may be utilized to request and manage resources from a variety of different resource providers (e.g., resource provider A 104, resource provider B 106, and resource provider C 108) and service providers. In one implementation, such APIs 122 may include REST APIs, although this is only a non-limiting example.

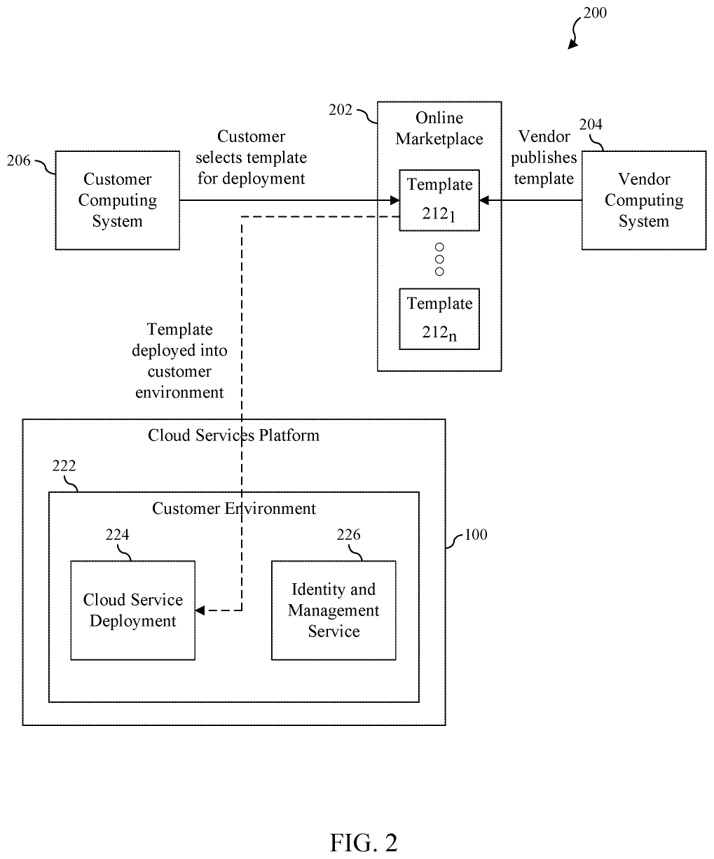

Cloud resource manager 102 also includes management tools 124. Management tools 124 may include a variety of user interfaces (UIs) that an administrator or other user may interact with to deploy, manage and monitor resources via cloud resource manager 102. For example, each of these UIs may be configured to interact with APIs 122 to invoke various features thereof. For example, such UIs may include but are not limited to a Web-based portal (e.g., Microsoft® Azure® Portal), a command line interface (CLI), an interactive command environment with scripting features (e.g., Microsoft® PowerShell®), and a development tool (e.g., Microsoft® Visual Studio®). As will be discussed below with respect to FIG. 2, cloud resource manager 102 also supports the deployment of one or more cloud services and the resources that support them via a template.

Cloud resource manager 102 also includes resource group functionality 126. Resource group functionality 126 is configured to enable resources for a cloud service to be grouped together for the purposes of deployment, management and monitoring. A resource group can be defined to include all the resources allocated to a given cloud service deployment for a customer environment or only a subset of such resources that a user wishes to manage as a group. Examples of an environment include, but are not limited to, an account associated with a user with respect to cloud services platform 100, a subscription associated with a user with respect to cloud service platform, etc.

Cloud resource manager 102 still further includes role-based access control (RBAC) functionality 128. RBAC functionality 128 may be used to ensure that only persons assigned to certain roles within an organization are able to manage resources or resource groups associated with a given cloud service deployment for a customer environment. Thus, for example, only certain roles may be enabled to interact with cloud resource manager 102 for the purposes of adding, deleting, modifying, configuring, or managing certain resources or resource groups associated with a given cloud service deployment for a customer environment.

With respect to the foregoing description of cloud services platform 100, it is to be understood that each of cloud resource manager 102, resource provider A 104, resource provider B 106, and resource provider C 108 may represent software executing on a computer or on one or more interconnected computers. For example, and without limitation, each of these components may be running as software on a collection of networked physical or virtual machines within one or more data centers that comprise cloud services platform 100. Furthermore, with respect to cloud service deployment 110, cloud service 112 may comprise software and resource A 114, resource B 116 and resource C 118 may comprise computing resources used to support the execution of such software (e.g., a virtual machine, a storage account, a Web application, a database, or a virtual network).

FIG. 2 is a block diagram that illustrates the use of templates to deploy a cloud service within cloud services platform 100. A template comprises a file (or other suitable container) that includes information that describes how a cloud service should be deployed within cloud services platform 100. For example, the template may specify resources of cloud services platform 100 that must be allocated in support of a given cloud service and how such resources should be configured. The template may further specify how the cloud service should be deployed on top of (i.e., in a manner that utilizes) such resources and how the cloud service should be configured. The template may be text-based, and may further be composed using a declarative syntax rather than imperative commands. In one implementation, the template is composed using a text-based data exchange format such as JavaScript Object Notation (JSON), although this is only an example.

As shown in FIG. 2, a cloud service vendor can utilize its own vendor computing system 204 to publish a template 212₁ to an online marketplace 202, wherein such template 212₁ provides information necessary for a customer to deploy the vendor's cloud service to the customer's own environment (i.e., to the customer's own set of resources) within cloud services platform 100. Template 212₁ may be made available along with a variety of other templates 212₂-212ₙ for consumption by one or more customers of cloud services. Each template made available in online marketplace 202 may be published by a variety of different cloud service vendors, by a proprietor of cloud services platform 100, or by other entities. Online marketplace 202 may offer hundreds or even thousands of templates. In one implementation, online marketplace 202 comprises the Microsoft® Azure® Marketplace, a Web site published by Microsoft Corporation of Redmond, Wash., although this is only an example.

Template 212₁ includes information necessary to deploy a vendor's cloud service offering within the customer's environment. For example, if the vendor's cloud service is a PaaS or SaaS application, template 212₁ may declare that a certain number of virtual machines, storage accounts, databases, network connections, and/or the like, each having a specified configuration, must first be allocated within the customer's environment by customer services platform 100 before deploying the PaaS/SaaS application. Template 212₁ may further declare that after such resources have been allocated, that certain specified code comprising the PaaS/SaaS application should be downloaded and installed on one or more of the resources (e.g., one or more virtual machines). Thus, templates may provide for a staged deployment of the cloud service, with certain deployment steps being dependent on the successful execution of certain previous deployment steps.

A template, such as template 212₁ may also declare that certain information, such as resource deployment settings, cloud service deployment settings, or the like, should be obtained from the customer during the deployment process. Accordingly, a deployment service that is utilized to manage the deployment process may present a UI for obtaining such information from the customer as part of the deployment process. Content of the UI and/or the information to be obtained via the UI may be specified by the vendor via a file (or other suitable container) that may be published along with a template and packaged therewith.

As shown in the example of FIG. 2, a customer using a customer computing system 206 may browse online marketplace 202 via a graphical UI (GUI) thereof and select template 212₁ for deployment to the customer's environment within cloud services platform 100, denoted customer environment 222. The customer may then initiate the deployment of template 212₁ via interaction with the aforementioned GUI.

In response to this initiation step, a marketplace service (which may comprise, for example, part of online marketplace 202) will deploy template 212₁, thereby causing an instance of the vendor's cloud service and the resources utilized thereby to be deployed within customer environment 222. In FIG. 2, this deployment within customer environment 222 is denoted cloud service deployment 224. As noted above, the deployment process may be staged in that certain resources may be allocated before other resources, and some or all resources may be allocated before the cloud service itself is installed. Also, as noted above, this deployment process may involve presenting a UI to the customer (e.g., via customer computing system 206) via which the customer can specify certain deployment settings for the resources to be allocated and for the cloud service itself.

When a customer signs up for cloud services from a provider of cloud services platform 100, the customer is provided access to a customer environment (e.g., a customer account, a customer subscription, etc.). The customer environment may be associated with a tenant. A tenant is a dedicated and trusted instance of a cloud-based identity and access management service 226. An example of such a service is Microsoft® Azure® Active Directory, although this is only an example and is not intended to be limiting. Cloud-based identity and access management service 226 is configured to assist users of customer environment 222 to sign-in to customer environment 222 and access resources allocated for cloud service deployment 224. The customer is assigned an access token that is provided to the customer upon a successful login to their environment. The access token identifies the customer (e.g., identifies the customer's tenant identifier). When the customer attempts to access a particular resource group and/or resource, RBAC functionality 128 determines the roles of the customer and/or determines the resource group(s) and/or resource(s) to which the customer has access based on the access token. The access token may be a JSON web token (JWT), although this is only an example and is not intended to be limiting.

Thus, as can be seen from the foregoing description, cloud services deployment system 200 enables vendors of SaaS and PaaS applications to publish templates in an online marketplace (e.g., the Microsoft® Azure® Marketplace), and for customers to deploy such applications into their environments. This can facilitate the creation of an ecosystem of self-service multi-resource applications. Through the above-described publication of templates, vendors can share best-practice configurations of complex PaaS and SaaS offerings, and customers can provision them in minutes. While the foregoing enables customers to use applications that previously would have required application-specific expertise and time-consuming set up, cloud services deployment system 200 still does not address certain issues and shortcomings associated with the deployment of a vendor's cloud service by a customer.

The following Section will describe a collection of features, provided by a cloud resource manager (e.g., a modified version of cloud resource manager 102 of FIG. 1) that together enable a service provider to manage resource group(s) and/or resource(s) for a given cloud service deployment for a customer environment.

### II. Service Provider Management of Customer Cloud-Based Resources

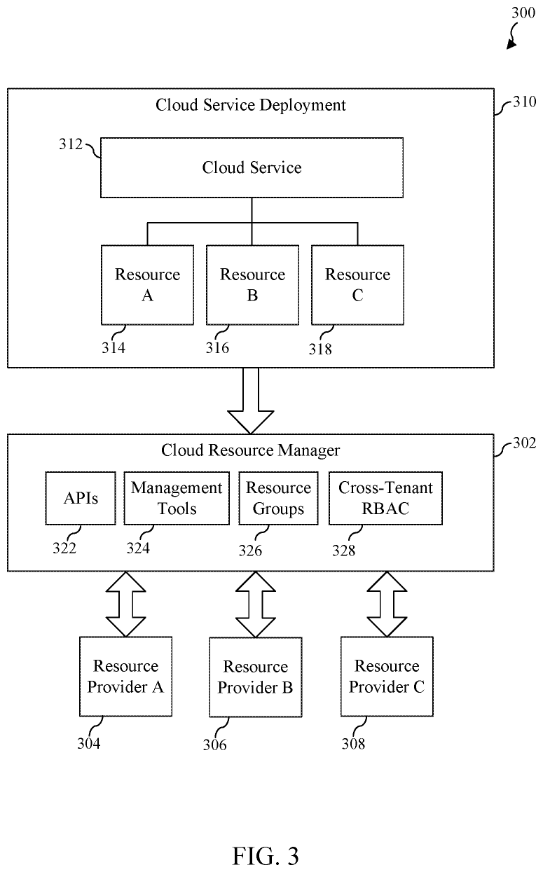

FIG. 3 is a block diagram of an example cloud services platform 300 that is configured to support the management of cloud resources by a service provider in accordance with an embodiment. As shown in FIG. 3, cloud services platform 300 includes a cloud resource manager 302, a plurality of resource providers including a resource provider A 304, a resource provider B 306, and a resource provider C 308, and a cloud service deployment 310. Each of these components will now be described.

Cloud resource manager 302 is substantially similar to cloud resource manager 102 as described above with respect to FIG. 1, except that cross-tenant RBAC 328 has been added thereto. Consequently, APIs 322, management tools 324, and resource group functionality 326 may each be configured to operate in a like manner respectively to APIs 122, management tools 124, and resource group functionality 126, as previously described with respect to FIG. 1.

The features of cloud resource manager 302 can be invoked programmatically or by a user to deploy, update, or delete resources that are themselves utilized to support a cloud service deployment. In FIG. 3, cloud resource manager 302 has deployed exemplary cloud service deployment 310. In one embodiment, cloud resource manager 302 comprises the Microsoft® Azure® Resource Manager, although this is only an example and is not intended to be limiting.

In an embodiment, cloud resource manager 302 may be configured to treat cloud service deployment 310 differently than cloud service deployment 110 as described above with respect to FIG. 1. For example, cloud resource manager 302 (e.g., via cross-tenant RBAC functionality 328) may grant access to cloud service deployment 310 to a service provider. Such access (referred to elsewhere herein as a “projection”) may be granted via a service provider environment in cloud services platform 300. Such access may advantageously enable the service provider to manage cloud service deployment 310 on behalf of the customer. Via this projection feature, service providers may be provided with full access to cloud resources for diagnostics and troubleshooting and may self-service update the deployed cloud resources. Via projections into multiple customer environments, service providers can manage resources of all the customer environments at scale without having to access each customer environment individually (e.g., via individually logging into each of the customer environments).

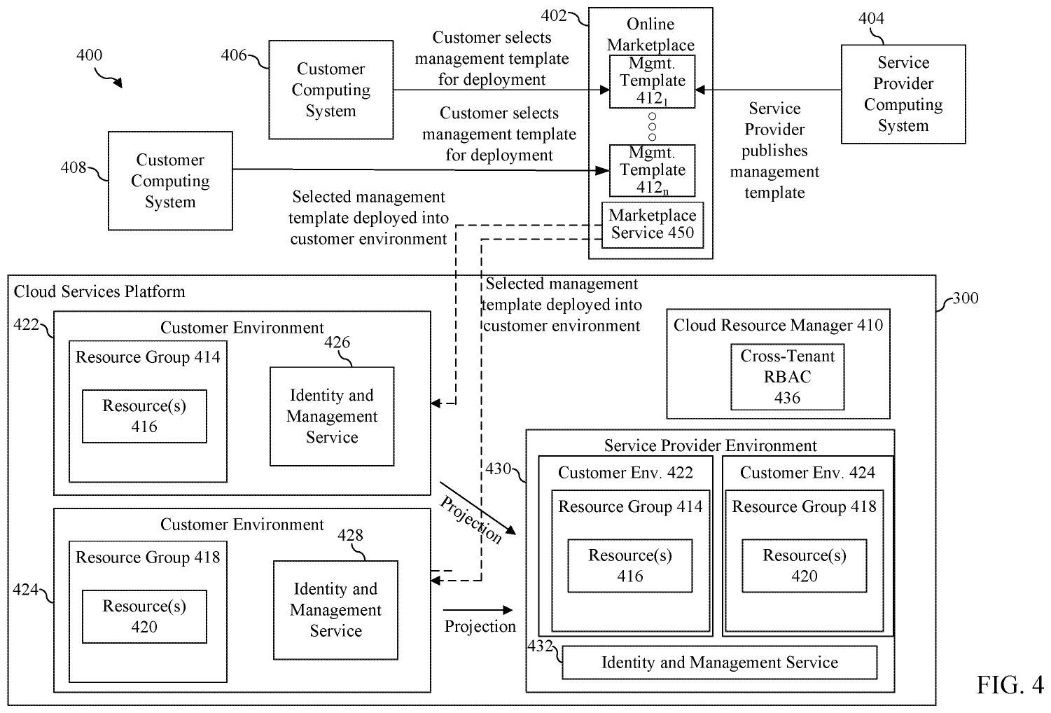

Also, as will be discussed below in more detail with respect to FIG. 4, cross-tenant RBAC 328 enables a service provider to manage cloud service deployments of multiple customers based on management templates provided by the service provider. For example, the service provider may publish the management templates to an online marketplace. The management templates specify access permissions that are to be granted to the service provider with respect to a customer's environment, resource groups and/or resources included therein. For example, the management template may specify whether a service provider is enabled to modify resources, read resources, delete resources and/or add new resources. Customers who desire to have their service deployments managed by a service provider may deploy the management template to their customer environment. Once a management template has been deployed for a particular customer environment, cross-tenant RBAC 328 associates the service provider's token with the customer environment. This enables customer environments, resource groups and/or resources included therein to be logically projected to the environment of the service provider, thereby enabling a service provider to manage multiple customer environments at scale. The management templates are a convenient way to define access permissions that can be customized for individual customer environments.

With respect to the foregoing description of cloud services platform 300, it is to be understood that each of cloud resource manager 302, resource provider A 304, resource provider B 306, and resource provider C 308 may represent software executing on a computer or on one or more interconnected computers. For example, and without limitation, each of these components may be running as software on a collection of networked physical or virtual machines within one or more data centers that comprise cloud services platform 300. Furthermore, with respect to appliance deployment 310, cloud service 312 may comprise software and resource A 314, resource B 316, resource C 318 and appliance management resource 320 may comprise computing resources used to support and/or manage the execution of such software.

FIG. 4 is a block diagram of a system 400 that illustrates a deployment of management templates to different customer environments that enables a service provider to manage the customer environments in accordance with an embodiment. Management templates may be text-based, and may further be composed using a declarative syntax rather than imperative commands. In one implementation, the template is composed using a text-based data exchange format such as JSON, although this is only an example.

As shown in FIG. 4, a service provider can utilize its own service provider computing system 404 to publish a management template 412₁ to an online marketplace 402 (e.g., via a UI thereof), wherein such management template 412₁ specifies access permissions that are to be granted to the service provider via the service provider's environment (shown as service provider environment 430) with respect to a customer's environment, resource groups and/or resources included therein. Management template 412₁ may be made available along with a variety of other management templates 412₂-412ₙ for consumption by one or more customers. Each management template made available in online marketplace 402 may be published by a variety of different service providers, by a proprietor of cloud services platform 300, or by other entities. Online marketplace 402 may offer hundreds or even thousands of management templates. Online marketplace 402 is an example of online marketplace 202, as described above with reference to FIG. 2. In one implementation, online marketplace 402 comprises the Microsoft® Azure® Marketplace, a Web site published by Microsoft Corporation of Redmond, Wash., although this is only an example. It is noted that management templates may be provided to customer environments using other techniques in lieu of online marketplace 402. For example, a management template may be obtained directly from a service provider and deployed to customer environments accordingly.

Other information may be packaged or otherwise included with the template to facilitate the management of resources for a particular customer. For example, such other information may also include identification information for the service provider (e.g., an identifications of the service provider's tenant), a listing of resources that the service provider is permitted to manage and/or the actions that service provider may take with respect to the customer environment and/or its resources. Examples of actions include, but are not limited to, creating a resource, updating a resource, reading a resource, and/or deleting a resource. Other actions include, but are not limited to, viewing and monitoring the health of resources, enabling/disabling security measures with respect to a resource, etc.

Management template(s) 412₁-412ₙ may comprise a default set of permissions for a given service provider and/or customer. Each of management template(s) 412₁-412ₙ may be modified (e.g., by the service provider and/or customer) to customize the permissions granted for the service provider before deployment thereof. In accordance with an embodiment, each of management template(s) 412₁-412ₙ may be modified to enable just-in-time access for the service provider, in which the service provider is enabled to perform an action with respect a particular resource allocated for the customer for a limited duration of time. The duration of time may be specified by the customer in the management template. Just-in-time access enables a more secure and restrictive access mechanism to meet compliance needs and avert security breaches.

Each of management template(s) 412₁-412ₙ may also specify security rules for allowing a service provider to access a customer's resources. For example, the customer can specify that a service provider is only allowed to access particular customer resources only after the service provider logs into his/her account using multi-factor authentication. This gives customers security controls that they can technically and automatically impose versus relying on manual or contractual enforcement.

As shown in the example of FIG. 4, the service provider has created an environment with respect to cloud services platform 300. The service provider environment is shown as service provider environment 430. Service provider environment 430 is associated with a tenant. That is, service provider environment 430 has an identity and management service 432 instantiated therefor. Identity and management service 432 is an example of identity and management service 226, as described above with reference to FIG. 2. Service provider environment 430 is associated with an access token provided by identity and management service 432. Service provider environment 430 is assigned and provided the access upon the service provider successfully logging into their environment. The access token identifies the service provider. The access token may be a JWT, although this is only an example and is not intended to be limiting.

As also shown in the example of FIG. 4, a first customer has deployed a resource group 414 comprising resource(s) 416 to an environment associated therewith, e.g., by deploying a template (e.g., template 212i), as described above with reference to FIG. 2. The first customer's environment is shown as customer environment 422. A second customer has deployed a resource group 418 comprising resource(s) 420 to an environment associated therewith, e.g., by deploying a template, as described above with reference to FIG. 2. The second customer's environment is shown as customer environment 424. As further shown in FIG. 4, each of first customer environment 422 and second customer environment 424 is associated with a different tenant. That is, first customer environment 422 has a first identity and management service 426 instantiated therefor, and second customer environment 424 has a second identity and management service 428 instantiated therefor. Each of first identity and management service 426 and second identity and management service 428 are examples of identity and management service 226, as described above with reference to FIG. 2. First customer environment 422 is associated with a first access token provided by identity and management service 426 upon the first customer successfully logging into first customer environment 422, and second customer environment 424 is associated with a second access token provided by identity and management service 428 upon the second customer successfully logging into second customer environment 424.

As further shown in FIG. 4, the first customer, using a first customer computing system 406, may browse online marketplace 402 (via a UI thereof) and select management template 412₁ for deployment to the customer's environment within cloud services platform 300 (i.e., customer environment 422). A second customer, using a second customer computing system 408, may browse online marketplace 402 (via a second UI thereof) and select management template 412ₙ for deployment to the customer's environment within cloud services platform 300 (i.e., customer environment 424). In response to these respective initiation steps, marketplace service 450 (which comprises part of online marketplace 402) will deploy template 412₁ within customer environment 422 and will deploy template 412ₙ within customer environment 424.

As also shown in FIG. 4, cloud services platform 300 includes a cloud resource manager 410, which is an example of cloud resource manager 302, as described above with reference to FIG. 4. Cloud resource manager 410 includes cross-tenant RBAC 436, which is an example of cross-tenant RBAC 328, as described above with reference to FIG. 3. Additional components of cross-tenant RBAC 436 are not shown for brevity. To enable a service provider to manage customer environments, resource groups and/or resources included therein on behalf of the customers, cloud resource manager 410 projects the customer environments and associated resource groups and/or resources into the environment of the service provider responsive to the management templates being deploying. For example, cloud resource manager 410 may monitor management template deployments to customer environments and project customer environments and associated resource group(s) and/or resource(s) to the service provider environment in accordance with the permissions specified by the management templates. For instance, upon deployment of management template 412₁, cloud resource manager 410 determines that management template 412₁ has been deployed to customer environment 422 and identifies the tenant of the service provider, identifies the tenant of the first customer, and/or specifies management permissions granted to the service provider (or certain user(s) and/or group(s) thereof) (i.e., specify permissions granted to resource groups (e.g., resource group 414) and/or resources (i.e., resource(s) 416)). Similarly, upon deployment of management template 412ₙ into customer environment 424, cloud resource manager 410 determines that management template 412ₙ has been deployed to customer environment 424 and identifies the tenant of the service provider, identify the tenant of the second customer, and/or specify management permissions granted to the service provider (or certain user(s) and/or group(s) thereof) (i.e., specify permissions granted to resource groups (e.g., resource group 418) and/or resources (i.e., resource(s) 420)). In accordance with an embodiment, only the resource groups and/or resources that are manageable by the service provider are projected to service provider environment 430.

Cross-tenant RBAC 436 may be used to ensure that only persons assigned to certain roles within the service provider's organization are able to manage resources or resource groups associated with cloud service deployments for customer environments associated with different tenants. Thus, for example, only certain roles may be enabled to interact with cloud resource manager 410 for the purposes of adding, deleting, modifying, configuring, or managing certain resources or resource groups associated with a given cloud service deployment for a customer environment.

Cross-tenant RBAC 436 maintains an association between the service provider's tenant identifier and the permissions granted for each group and user of the service provider with respect to customer environments 422 and 424. Upon deployment of a management template 412₁, cross-tenant RBAC 436 associates the permissions granted to the service provider with respect to customer environment 422 to the service provider's tenant identifier. Upon deployment of management template 412ₙ, cross-tenant RBAC 436 associates the permissions granted to the service provider with respect to customer environment 424 to the service provider's tenant identifier.

When the service provider logs into service provider environment 430, identity and management service 432 provides the access token (that identifies the service provider's tenant) to cross-tenant RBAC 436 of cloud resource manager 410. Cross-tenant RBAC 436 determines the service provider's tenant identifier from the access token and retrieves the permissions associated with the service provider's tenant identifier. Cloud resource manager 410 logically projects the customer environments (and associated resource groups and/or resource(s)) into service provider environment 430 in accordance with the retrieved permissions.

As shown in FIG. 4, customer environment 422 (and its associated resource group 414 and resource(s) 416) and customer environment 424 (and its associated resource group 48 and resource(s) 420) are projected into service provider environment 430 within cloud services platform 300. The projection results in customer environment 422, resource group 414, resource(s) 416, customer environment 424, resource group 418, and resource(s) 420 logically appearing in the service provider environment 430. The service provider can use this access to manage, monitor and/or troubleshoot the operation of resource group 414, resource(s) 416, resource group 418, and resource(s) 420 on behalf of the first and customers.

When a service provider desires to perform an action with respect to a resource being managed, the service provider may issue a request specifying the action. The request comprises the service provider's access token. The request is received by cross-tenant RBAC 436, which determines the service provider's tenant identifier from the access token. Using the service provider's tenant identifier, cross-tenant RBAC 436 determines the permissions granted therefor and determines whether the requested action is permissible by the service provider. If the action is permissible, the action is performed with respect to the resource. Otherwise, the action is denied. Any request received by cross-tenant RBAC 436 that does include the access token of the service provider that is authorized to manage customer environments 422 and/or 424 do not cause any action to be performed with respect to such customer environments 422 and/or 424.

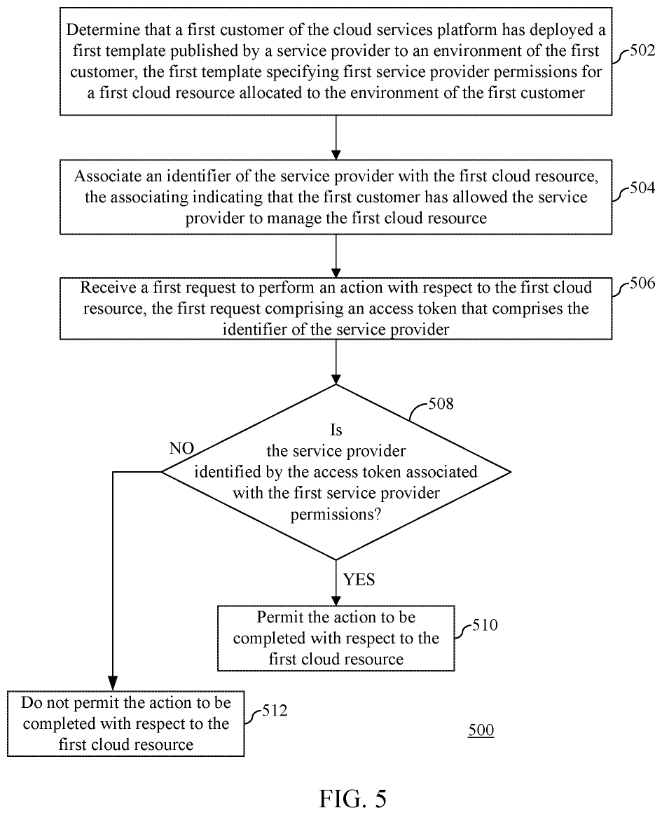

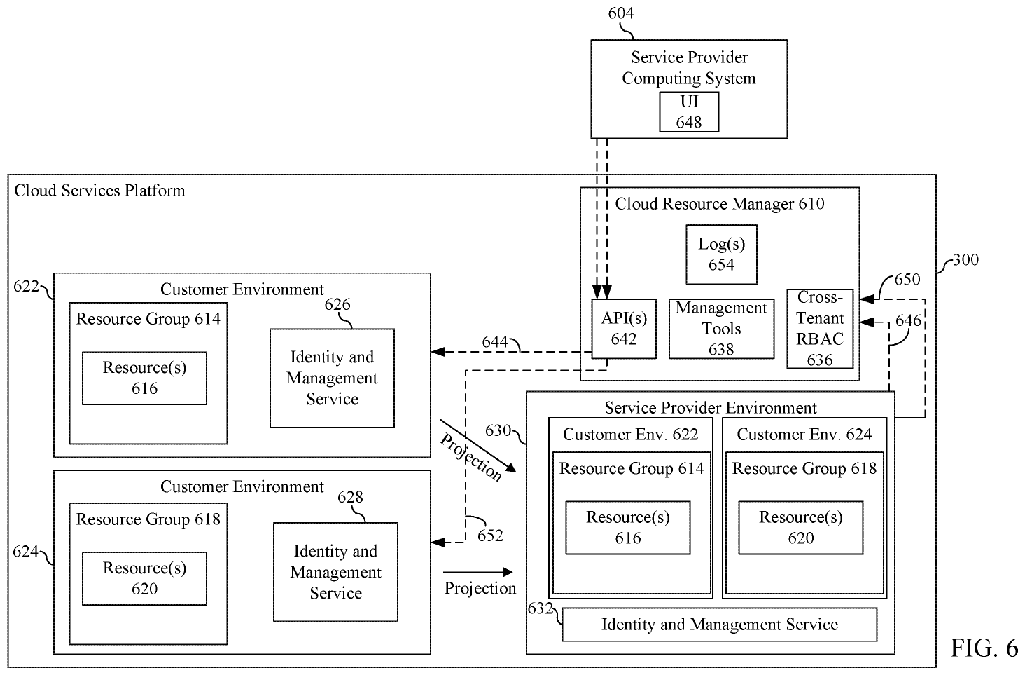

FIG. 5 shows a flowchart 500 of a method for enabling a service provider to manage a customer environment, according to an example embodiment. In an embodiment, flowchart 500 may be implemented cloud services platform 300, as shown in FIGS. 4 and 6. FIG. 6 is a block diagram of a system 600 for enabling a service provider to manage a customer environment, according to an example embodiment. As shown in FIG. 6, system 600 includes cloud services platform 300 and a service provider computing system 604. Service provider computing system 604 is an example of service provider computing system 404, as described above with reference to FIG. 4. As also shown in FIG. 6, cloud services platform 300 comprises a first customer environment 622 associated with a first customer, a second customer environment 624 associated with a second customer, and a service provider environment 630 associated with a service provider. Customer environment 622 has a resource group 614 with resource(s) 616 deployed therefor and an identity and management service 626 instantiated therefor. Customer environment 624 has a resource group 618 with resource(s) 620 deployed therefor and an identity and management service 628 instantiated therefor. Service provider environment 630 has an identity and management service 632 instantiated therefor. As further shown in FIG. 6, cloud services platform 300 comprises cloud resource manager 610, which comprises management tools 638, cross-tenant RBAC 636, and API(s) 642. Customer environment 622, customer environment 624, resource group 614, resource group 618, resource(s) 616, resource(s) 620, identity and management service 626, identity and management service 628, identity and management service 632, service provider environment 630, cloud resource manager 610, management tools 638, cross-tenant RBAC 636, and API(s) 642 are examples of customer environment 422, customer environment 424, resource group 414, resource group 418, resource(s) 416, resource(s) 420, identity and management service 426, identity and management service 428, identity and management service 432, service provider environment 430, cloud resource manager 410, management tools 324, cross-tenant RBAC 436, and API(s) 322, as respectively described above with reference to FIGS. 3 and 4. Each of customer environment 622 and customer environment 624 has deployed a management template (not shown) associated with the service provider, thereby enabling the service provider to manage customer environments 622 and 644. Other structural and operational embodiments will be apparent to persons skilled in the relevant art(s) based on the following discussion regarding flowchart 500 and systems 400 and 600 of FIGS. 4 and 6.

Flowchart 500 of FIG. 5 begins with step 502. In step 502, a determination is made that a first customer of the cloud services platform has deployed a first template published by a service provider to an environment of the first customer, the first template specifying first service provider permissions for a first cloud resource allocated to the environment of the first customer environment. For example, with reference to FIG. 4, a first customer of cloud service platform 300 has deployed management template 412₁ published by a service provider to first customer environment 422. Management template 412₁ specifies first service provider permissions for a first cloud resource (e.g., resource group 414 and/or resource(s) 416) allocated to first customer environment 422. Upon deploying management template 412₁, cloud resource manager 410 determines that the first customer has deployed management template 412₁.

In step 504, responsive to determining that the first customer of the cloud services platform has deployed the first template, an identifier of the service provider is associated with the first cloud resource, the associating indicating that the first customer has allowed the service provider to manage the first cloud resource. For example, with reference to FIG. 4, cross-tenant RBAC 436 determines the service provider's tenant identifier and an identification of the resource group(s) and/or resource(s) (e.g., resource group 414 and/or resource(s) 416 for which the service provider has been granted management permissions. Cross-tenant RBAC 436 associates the identified resource group and/or resource(s) to the service provider's tenant identifier. Such associating indicates that the first customer has allowed the service provider to manage the identified resource group(s) and/or resource(s).

In step 506, a first request to perform an action with respect to the first cloud resource is received. The first request comprises an access token that comprises the identifier of the service provider. For example, with reference to FIG. 6, a service provider may request to perform an action with respect to resource group 614 and/or resource(s) 606. For instance, the service provider, using service provider computing system 604, may access management tools 638 to access the service provider's environment (service provider environment 630). Management tools 638 may present a UI 648 displaying customer environment 622, resource group 614, and/or resource(s) 616 (i.e., the resources of the first customer that are manageable by the service provider). The service provider, using UI 648, may select a UI option corresponding to the action the service provider wishes to perform with respect to resource group 614 and/or resource(s) 616. Upon selecting the UI option, a request 646 may be provided from service provider environment 630 to cross-tenant RBAC 636. Request 646 comprises the access token of the service provider (as provided by identity and management service 632) (i.e., the service provider that is designated as being permitted to manage the resources of customer environment 622). The access token comprises access-related parameters along with the tenant identifier of the service provider.

In accordance with an embodiment, the access token is provided to the service provider responsive to the service provider logging into a service provider environment associated with the service provider. For example, with reference to FIG. 6, identity and management service 632 provides the access token to the service provider responsive to the service provider successfully logging into service provider environment 630.

In step 508, a determination is made as to whether the service provider identified by the access token is associated with the first service provider permissions. If a determination is made that the service provider is associated with the first service provider permissions, flow continues to step 510. Otherwise, flow continues to step 512. For example, with reference to FIG. 6, cross-tenant RBAC 636 determines whether the service provider identified by the access token is associated with the first service provider permissions.

In step 510, responsive to determining that the service provider identified by the access token is associated with the first service provider permissions, the action is permitted to be completed with respect to the first cloud resource. For example, with reference to FIG. 6, responsive to determining that the service provider identified by the access token is associated with the first service provider permissions, cross-tenant RBAC 636 permits the action to be completed with respect to resource group 614 and/or resource(s) 616. For example, API(s) 642 may provide a command 644 to first customer environment 622 that causes the action to be performed with respect to resource group 614 and/or resource(s) 616.

In accordance with one or more embodiments, the service provider is provided a limited duration of time to perform the action, the limited duration of time being specified by the first customer via the first template. For example, with reference to FIG. 4, before deployment of management template 412₁, the customer may additionally specify in management template 412₁ that the service provider has just-in-time access with a particular resource. The customer may further specify the limited duration of time in which the service provider may perform the action in management template 412₁.

In step 512, the action is not permitted to be completed with respect to the first cloud resource. For example, with reference to FIG. 6, cross-tenant RBAC 636 denies the action to be performed, as the service provider does not have the permissions to manage the first cloud resource.

In accordance with one or more embodiments, the action is logged in an activity log that is accessible to both the service provider and the first customer. For example, with reference to FIG. 6, cloud resource manager 610 stores and maintains log(s) 654 that store information pertaining to the actions performed by the service provider. The information may include, but is not limited to, the service provider's tenant identifier, the resource group(s) and/or resource(s) on which the action was performed, and a description of the action that was performed. Log(s) 654 are accessible to both the service provider and the first customer. For example, the service provider may access log(s) 654 via management tools 638 that are accessible via service provider computing system 604, and the first customer may access log(s) 654 via management tools 638 via management tools 638 that are accessible via customer computing system 406, as shown in FIG. 4.

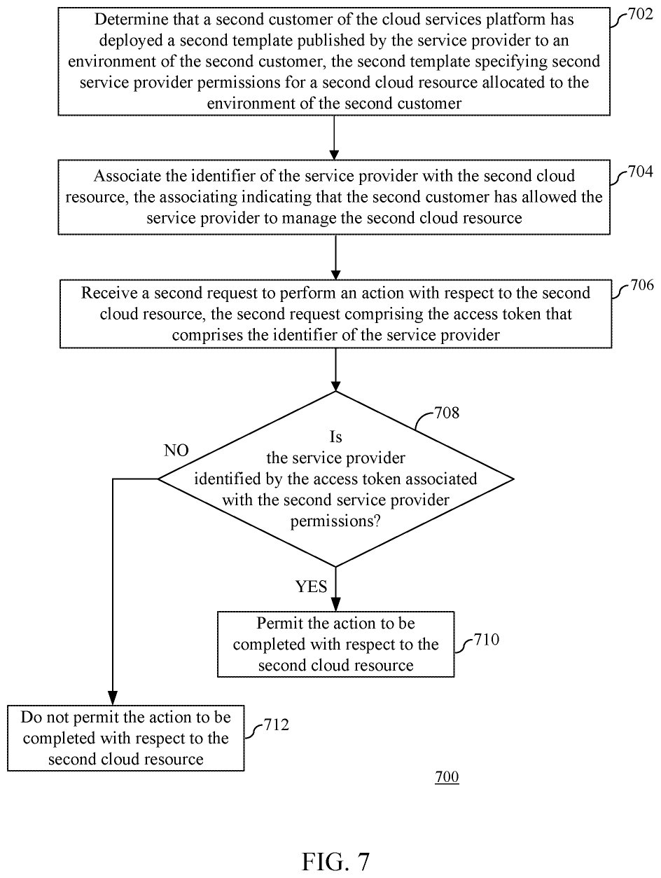

FIG. 7 shows a flowchart 700 of a method for enabling the service provider to manage a second customer environment, according to an example embodiment. In an embodiment, flowchart 700 may be implemented cloud services platform 300, as shown in FIGS. 4 and 6. Accordingly, flowchart 700 will be described with continued reference to FIGS. 4 and 6. Other structural and operational embodiments will be apparent to persons skilled in the relevant art(s) based on the following discussion regarding flowchart 700 and systems 400 and 600 of FIGS. 4 and 6.

Flowchart 700 of FIG. 7 begins with step 702. In step 702, a determination is made that a second customer of the cloud services platform has deployed a second template published by a service provider to an environment of the second customer, the second template specifying second service provider permissions for a second cloud resource allocated to the environment of the second customer environment. For example, with reference to FIG. 4, a second customer of cloud service platform 300 has deployed management template 412ₙ published by the service provider to second customer environment 424. Management template 412ₙ specifies permissions for the second service provider for a second cloud resource (e.g., resource group 418 and/or resource(s) 420) allocated to first customer environment 424. Upon deploying management template 412ₙ, cloud resource manager 410 determines that the second customer has deployed management template 412ₙ.

In step 704, responsive to determining that the second customer of the cloud services platform has deployed the second template, an identifier of the service provider is associated with the second cloud resource, the associating indicating that the second customer has allowed the service provider to manage the second cloud resource. For example, with reference to FIG. 6, cross-tenant RBAC 636 determines the service provider's tenant identifier and an identification of the resource group(s) and/or resource(s) (e.g., resource group 418 and/or resource(s) 420) for which the service provider has been granted management permissions. Cross-tenant RBAC 436 associates the identified resource group and/or resource(s) to the service provider's tenant identifier. Such associating indicates that the second customer has allowed the service provider to manage the identified resource group(s) and/or resource(s).

In step 706, a second request to perform an action with respect to the second cloud resource is received. The second request comprises the access token that comprises the identifier of the service provider. For example, with reference to FIG. 6, a service provider may request to perform an action with respect to resource group 618 and/or resource(s) 620. For instance, the service provider, using service provider computing system 604, may access management tools 638 to access the service provider's environment (service provider environment 630). Management tools 638 may present UI 648 displaying customer environment 624, resource group 618, and/or resource(s) 620 (i.e., the resources of the first customer that are manageable by the service provider). The service provider, using UI 648, may select a UI option corresponding to the action the service provider wishes to perform with respect to resource group 618 and/or resource(s) 620. Upon selecting the UI option, a request 650 may be provided from service provider environment 630 to cross-tenant RBAC 636. Request 650 comprises the access token of the service provider (as provided by identity and management service 632) (i.e., the service provider that is designated as being permitted to manage the resources of customer environment 624). The access token comprises access-related parameters along with the tenant identifier of the service provider.

In step 708, a determination is made as to whether the service provider identified by the access token is associated with the second service provider permissions. If a determination is made that the service provider is associated with the second service provider permissions, flow continues to step 510. Otherwise flow continues to step 712. For example, with reference to FIG. 7, cross-tenant RBAC 636 determines whether the service provider identified by the access token is associated with the second service provider permissions.

In step 710, responsive to determining that the service provider identified by the access token is associated with the second service provider permissions, the action is permitted to be completed with respect to the second cloud resource. For example, with reference to FIG. 6, responsive to determining that the service provider identified by the access token is associated with the second service provider permissions, cross-tenant RBAC 636 permits the action to be completed with respect to resource group 618 and/or resource(s) 620. For example, API(s) 642 may provide a command 652 to second customer environment 624 that causes the action to be performed with respect to resource group 618 and/or resource(s) 620

In step 712, the action is not permitted to be completed with respect to the second cloud resource. For example, with reference to FIG. 6, cross-tenant RBAC 636 denies the action to be performed, as the service provider does not have the permissions to manage the first cloud resource.

In accordance with one or more embodiments, the service provider is associated with a first tenant of the cloud services platform, the first customer is associated with a second tenant of the cloud services platform, and the second customer is associated with a third tenant of the cloud services platform. For example, with reference to FIG. 6, the service provider is associated with identity and management service 632, the first customer is associated with identity and management service 626, and the second customer is associated with identity and management service 628.

In accordance with one or more embodiments, the first template and the second template are published to an online marketplace by the service provider and are selectable for deployment by at least one of the first customer or the second customer. For example, with reference to FIG. 4, management templates 412₁ and 412ₙ are published to online marketplace 402 by the service provider (e.g., via service provider computing system 404) and is selectable for deployment by at least one of the first customer (e.g., via first customer computing system 406) or second customer (e.g., via second customer computing system 408).

In accordance with one or more embodiment, at least one of the first cloud resource or the second cloud resource comprise one or more of a virtual machine, a Platform-as-a-Service (PaaS) application, a Software-as-a-Service (SaaS) application, a storage account, a Web application, a database, or a virtual network.

As demonstrated above, a single access token of a service provider is utilized to provide access to multiple customer environments. This advantageously enables the customer environments to be logically projected into the service provider's environment upon the service provider logging into his environment. Moreover, the service provider is enabled to manage various resources of multiple customer environments at scale.

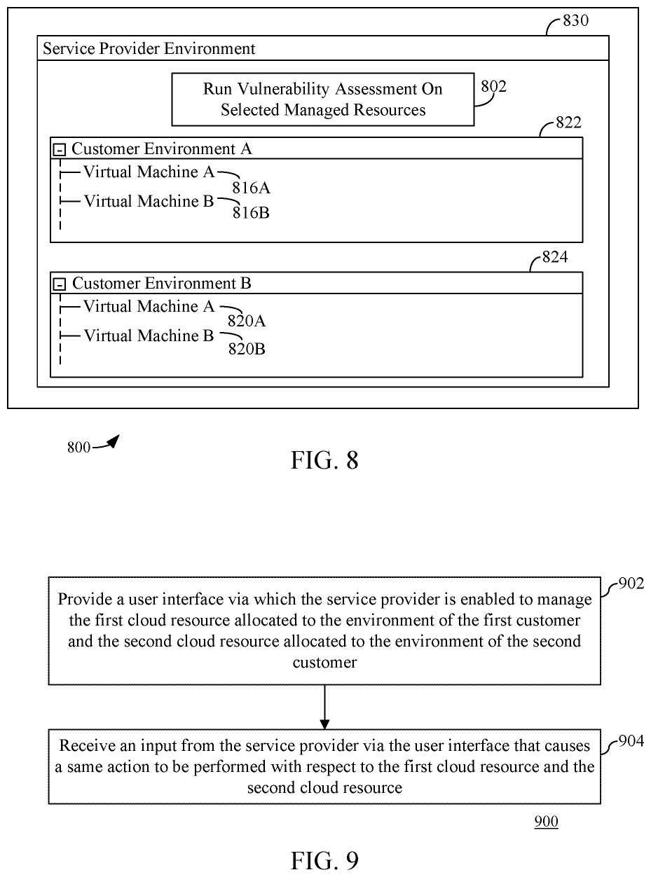

For example, FIG. 8 is an example UI screen 800 displaying a service provider environment in accordance with an embodiment. As shown in FIG. 8, UI screen 800 shows a graphical representation of service provider environment 830. UI screen 800 is an example of UI 648, and service provider environment 830 is an example of service provider environment 630, as described above with reference to FIG. 6. Within service provider environment 830 are graphical representations of the customer environments that the service provider is permitted to manage via service provider environment 830. For example, as shown in FIG. 8, service provider environment 830 comprises Customer Environment A 822 and Customer Environment B 824. Customer Environment A 822 and Customer Environment B 824 are examples of first customer environment 622 and second customer environment 624, as respectively shown in FIG. 6. As further shown in FIG. 8, within Customer Environment A 822 and Customer Environment B 824, the resources being managed by the service provider are shown. For example, as shown in FIG. 8, Customer Environment A 822 comprises Virtual Machine A 816A and Virtual Machine B 816B, and Customer Environment B 824 comprises Virtual Machine A 820A and Virtual Machine B 820B. Virtual Machine A 816A and Virtual Machine B 816B are examples of resource(s) 616, and Virtual Machine A 820A and Virtual Machine B 820B are examples of resource(s) 620, as respectively shown in FIG. 6.

Using UI screen 800, the service provider is enabled to select any of resources 816A, 816B, 820A, and/or 820B and perform one or more actions with respect thereto. The same action(s) may be performed at scale, across various resources allocated for different customer environments and tenants. For example, in the example shown in FIG. 8, an exemplary user interface element 802 is provided via UI screen 800. User interface element 802, when activated by the service provider (e.g., via an input device, such as a mouse, keyboard, touch screen, stylus, etc.), performs a vulnerability assessment for each of resources 816A, 816B, 820A, and/or 820B that are selected. It is noted that the UI screen 800 is purely exemplary and that UI screen 800 may comprise different and/or additional graphical components. It is further noted that the vulnerability assessment action described above is purely exemplary and any number of action(s) may be performed at scale (e.g., security-related tasks, monitoring-related tasks, etc.).

FIG. 9 shows a flowchart 900 of a method for performing an action with respect to a plurality of resources at scale, according to an example embodiment. In an embodiment, flowchart 900 may be implemented by cloud services platform 300, as shown in FIGS. 4 and 6. Accordingly, flowchart 900 will be described with continued reference to FIGS. 4 and 6, along with FIG. 8. Other structural and operational embodiments will be apparent to persons skilled in the relevant art(s) based on the following discussion regarding flowchart 900, systems 400 and 600 of FIGS. 4 and 6, and UI screen 800 of FIG. 8.

Flowchart 900 of FIG. 9 begins with step 902. In step 902, a user interface via which the service provider is enabled to manage the first cloud resource allocated to the environment of the first customer and the second cloud resource allocated to the environment of the second customer environment is provided. For example, with reference to FIG. 6, management tools 638 provides UI 648 that enables the service provider to manage first cloud resources (e.g., resource group 614 and/or resource(s) 616) allocated to first customer environment 622 and second cloud resources (e.g., resource group 618 and/or resource(s) 620) allocated to second customer environment 624. As shown in FIG. 8, UI screen 800 provides a user interface via which the service provider is enabled to manage cloud resources 816A and 816B allocated for Customer Environment A 822 and cloud resources 820A and 820B allocated for Customer Environment B 824.

In step 904, an input is received from the service provider via the user interface that causes a same action to be performed with respect to the first cloud resource and the second cloud resource. For example, with reference to FIG. 6, UI 648 receives an input from the service provider that causes a same action to be performed with respect to the first cloud resource and the second cloud resource. The input is provided to cloud resource manager 610. The input specifies the action and/or the resources for which the action is to be performed. With reference to FIG. 8, the service provider activates user interface element 802, which causes a vulnerability assessment to be performed with respect to each of resources 816A, 816B, 820A, and/or 820B that are selected via UI screen 800.

Referring again to FIG. 6, upon receiving the input, API(s) 642 provide a command (e.g., commands 644 and 652) to each of the customer environments, and the action specified by the input is performed with respect to the resource(s) selected by the service provider (i.e., resource(s) 616 and resource(s) 618).

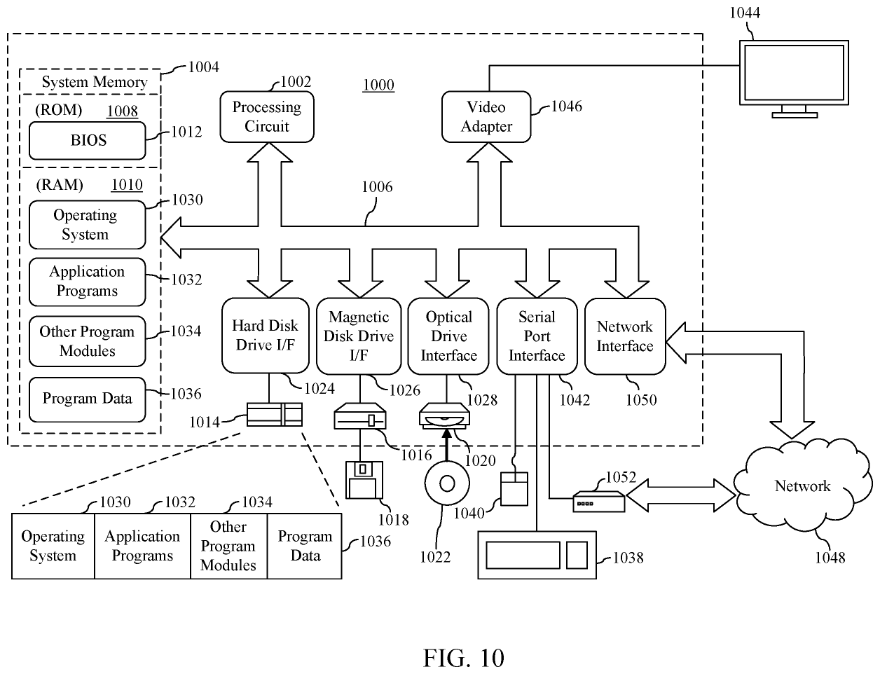

FIG. 10 depicts an example processor-based computer system 1000 that may be used to implement various embodiments described herein, such as any of the embodiments described above with respect to FIGS. 1-9. For example, system 1000 may be used to implement or execute any of the elements of cloud services platform 300 as described above with respect to FIGS. 3, 4, and 6, any of the elements of system 400 as described above with respect to FIG. 4, and any elements of system 600 as described above with respect to FIG. 6. System 1000 may also be used to implement or execute the method of flowchart 500, as described above with respect to FIG. 5, the method of flowchart 700, as described above with respect to FIG. 7, and the method of flowchart 900, as described above with respect to FIG. 9. The description of system 1000 provided herein is provided for purposes of illustration, and is not intended to be limiting. Embodiments may be implemented in further types of computer systems, as would be known to persons skilled in the relevant art(s).

### III. Example Computer System Implementation

As shown in FIG. 10, system 1000 includes a processing circuit 1002, a system memory 1004, and a bus 1006 that couples various system components including system memory 1004 to processing circuit 1002. Processing circuit 1002 may comprise one or more microprocessors or microprocessor cores. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random access memory (RAM) 1010. A basic input/output system 1012 (BIOS) is stored in ROM 1008.

System 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, BLU-RAY™ disk or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 1030, one or more application programs 1032, other program modules 1034, and program data 1036. In accordance with various embodiments, the program modules may include computer program logic that is executable by processing unit 1002 to implement any of the embodiments described in Section II above and with respect to FIGS. 1-9.

A user may enter commands and information into system 1000 through input devices such as a keyboard 1038 and a pointing device 1040 (e.g., a mouse). Other input devices (not shown) may include a microphone, joystick, game controller, scanner, or the like. In one embodiment, a touch screen is provided in conjunction with a display 1044 to allow a user to provide user input via the application of a touch (as by a finger or stylus for example) to one or more points on the touch screen. These and other input devices are often connected to processing unit 1002 through a serial port interface 1042 that is coupled to bus 1006, but may be connected by other interfaces, such as a parallel port, game port, or a universal serial bus (USB). Such interfaces may be wired or wireless interfaces.

Display 1044 is connected to bus 1006 via an interface, such as a video adapter 1046. In addition to display 1044, system 1000 may include other peripheral output devices (not shown) such as speakers and printers.

System 1000 is connected to a network 1048 (e.g., a local area network or wide area network such as the Internet) through a network interface 1050, a modem 1052, or other suitable means for establishing communications over the network. Modem 1052, which may be internal or external, is connected to bus 1006 via serial port interface 1042.

As used herein, the terms “computer program medium,” “computer-readable medium,” and “computer-readable storage medium” are used to generally refer to memory devices or storage structures such as the hard disk associated with hard disk drive 1014, removable magnetic disk 1018, removable optical disk 1022, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1032 and other program modules 1034) may be stored on the hard disk, magnetic disk, optical disk, ROM, or RAM. Such computer programs may also be received via network interface 1050, serial port interface 1042, or any other interface type. Such computer programs, when executed or loaded by an application, enable system 1000 to implement features of embodiments discussed herein. Accordingly, such computer programs represent controllers of the system 1000.

Embodiments are also directed to computer program products comprising software stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

### IV. Additional Exemplary Embodiments

A method implemented by a cloud services platform is described herein. The method includes: determining that a first customer of the cloud services platform has deployed a first template published by a service provider to an environment of the first customer, the first template specifying first service provider permissions for a first cloud resource allocated to the environment of the first customer; responsive to determining that the first customer of the cloud services platform has deployed the first template, associating an identifier of the service provider with the first cloud resource, the associating indicating that the first customer has allowed the service provider to manage the first cloud resource; receiving a first request to perform an action with respect to the first cloud resource, the first request comprising an access token that comprises the identifier of the service provider; determining whether the service provider identified by the access token is associated with the first service provider permissions; and responsive to determining that the service provider identified by the access token is associated with the first service provider permissions, permitting the action to be completed with respect to the first cloud resource.

In one embodiment of the foregoing method, the method further comprises: determining that a second customer of the cloud services platform has deployed a second template published by the service provider to an environment of the second customer, the second template specifying second service provider permissions for a second cloud resource allocated to the environment of the second customer; responsive to determining that the second customer of the cloud services platform has deployed the second template, associating the identifier of the service provider with the second cloud resource, the associating indicating that the second customer has allowed the service provider to manage the second cloud resource; receiving a second request to perform an action with respect to the second cloud resource, the second request comprising the access token that comprises the identifier of the service provider; determining whether the service provider identified by the access token is associated with the second service provider permissions; and responsive to determining that the service provider identified by the access token is associated with the second service provider permissions, permitting the action to be completed with respect to the second cloud resource.

In another embodiment of the foregoing method, the service provider is associated with a first tenant of the cloud services platform, wherein the first customer is associated with a second tenant of the cloud services platform, and wherein the second customer is associated with a third tenant of the cloud services platform.

In a further embodiment of the foregoing method, the first template and the second template are published to an online marketplace by the service provider and are selectable for deployment by at least one of the first customer or the second customer

In yet another embodiment of the foregoing method, the method further comprises: providing a user interface via which the service provider is enabled to manage the first cloud resource allocated to the environment of the first customer and the second cloud resource allocated to the environment of the second customer; and receiving an input from the service provider via the user interface that causes a same action to be performed with respect to the first cloud resource and the second cloud resource.

In still another embodiment of the foregoing method, at least the first cloud resource or the second cloud resource comprises one or more of: a virtual machine; a Platform-as-a-Service (PaaS) application; a Software-as-a-Service (SaaS) application; a storage account; a Web application, a database; or a virtual network.

In a further embodiment of the foregoing method, the method further comprises: providing the service provider a limited duration of time to perform the action, the limited duration of time being specified by the first customer via the first template.

In still another embodiment of the foregoing method, the access token is provided to the service provider responsive to the service provider logging into an environment associated with the service provider.

In a further embodiment of the foregoing method, the method further comprises: logging the action in an activity log that is accessible to both the service provider and the first customer.

A system comprising at least one processing circuit and at least one memory that stores program code configured to be executed by the at least one processor circuit is described herein. The program code comprises: a cloud resource manager of a cloud services platform configured to: determine that a first customer of the cloud services platform has deployed a first template published by a service provider to an environment of the first customer, the first template specifying first service provider permissions for a first cloud resource allocated to the environment of the first customer; responsive to determining that the first customer of the cloud services platform has deployed the first template, associate an identifier of the service provider with the first cloud resource, the association indicating that the first customer has allowed the service provider to manage the first cloud resource; receive a first request to perform an action with respect to the first cloud resource, the first request comprising an access token that comprises the identifier of the service provider; determine whether the service provider identified by the access token is associated with the first service provider permissions; and responsive to determining that the service provider identified by the access token is associated with the first service provider permissions, permit the action to be completed with respect to the first cloud resource.

In one embodiment of the foregoing system, the cloud resource manager is further configured to: determine that a second customer of the cloud services platform has deployed a second template published by the service provider to an environment of the second customer, the second template specifying second service provider permissions for a second cloud resource allocated to the environment of the second customer; responsive to determining that the second customer of the cloud services platform has deployed the second template, associate the identifier of the service provider with the second cloud resource, the association indicating that the second customer has allowed the service provider to manage the second cloud resource; receive a second request to perform an action with respect to the second cloud resource, the second request comprising the access token that comprises the identifier of the service provider; determine whether the service provider identified by the access token is associated with the second service provider permissions; and responsive to determining that the service provider identified by the access token is associated with the second service provider permissions, permit the action to be completed with respect to the second cloud resource.

In another embodiment of the foregoing system, the service provider is associated with a first tenant of the cloud services platform, wherein the first customer is associated with a second tenant of the cloud services platform, and wherein the second customer is associated with a third tenant of the cloud services platform.

In yet another embodiment of the foregoing system, the first template and the second template are published to an online marketplace by the service provider and are selectable for deployment by at least one of the first customer or the second customer.

In still another embodiment of the foregoing system, the cloud resource manager is further configured to provide a user interface via which the service provider is enabled to manage the first cloud resource allocated to the environment of the first customer and the second cloud resource allocated to the environment of the second customer; and receive an input from the service provider via the user interface that causes a same action to be performed with respect to the first cloud resource and the second cloud resource.

In a further embodiment of the foregoing system, at least the first cloud resource or the second cloud resource comprises one or more of: a virtual machine; a Platform-as-a-Service (PaaS) application; a Software-as-a-Service (SaaS) application; a storage account; a Web application, a database; or a virtual network.

In still another embodiment of the foregoing system, the cloud resource manager is further configured to: provide the service provider a limited duration of time to perform the action, the limited duration of time being specified by the first customer via the first template.

In a further embodiment of the foregoing system, the access token is provided to the service provider responsive to the service provider logging into an environment associated with the service provider.

In still another embodiment of the foregoing system, the cloud resource manager is further configured to: log the action in an activity log that is accessible to both the service provider and the first customer.

A computer-implemented system for managing cloud resources of a cloud services platform is further described herein. The computer-implemented system comprises: a first user interface (UI) that enables a first customer to deploy a first template published by a service provider, the deployment of the first template causing a first cloud resource deployed to an environment of the first customer to be manageable by the service provider; a second UI that enables a second customer to deploy a second template published by the service provider, the deployment of the second template causing a second cloud resource deployed to an environment of the second customer to be manageable by the service provider; and a third UI that enables the service provider to take actions with respect to both the first cloud resource and the second cloud resource via a single input.

In one embodiment of the foregoing computer-implemented, the actions comprise one or more of: updating the first cloud resource and the second cloud resource; reading the first cloud resource and the second cloud resource; deleting the first cloud resource and the second cloud resource; performing a security-related task with respect to the first cloud resource and the second cloud resource; or performing a maintenance-related task with respect to the first cloud resource and the second cloud resource.

### V. Conclusion

While various embodiments have been described above, it should be understood that they have been presented by way of example only, and not limitation. It will be understood by those skilled in the relevant art(s) that various changes in form and details may be made therein without departing from the spirit and scope of the described embodiments as defined in the appended claims. Accordingly, the breadth and scope of the present embodiments should not be limited by any of the above-described exemplary embodiments, but should be defined only in accordance with the following claims and their equivalents.

What is claimed is:

1. A method implemented by a cloud services platform, comprising:
determining that a first customer of the cloud services platform has deployed a first template published by a service provider to an environment of the first customer, the first template specifying first service provider permissions for a first cloud resource allocated to the environment of the first customer;
responsive to determining that the first customer of the cloud services platform has deployed the first template, associating an identifier of the service provider with the first cloud resource, the associating indicating that the first customer has allowed the service provider to manage the first cloud resource;
receiving a first request to perform an action with respect to the first cloud resource, the first request comprising an access token that comprises the identifier of the service provider;
determining whether the service provider identified by the access token is associated with the first service provider permissions; and
responsive to determining that the service provider identified by the access token is associated with the first service provider permissions, permitting the action to be completed with respect to the first cloud resource.

2. The method of claim 1, further comprising:
determining that a second customer of the cloud services platform has deployed a second template published by the service provider to an environment of the second customer, the second template specifying second service provider permissions for a second cloud resource allocated to the environment of the second customer;
responsive to determining that the second customer of the cloud services platform has deployed the second template, associating the identifier of the service provider with the second cloud resource, the associating indicating that the second customer has allowed the service provider to manage the second cloud resource;
receiving a second request to perform an action with respect to the second cloud resource, the second request comprising the access token that comprises the identifier of the service provider;
determining whether the service provider identified by the access token is associated with the second service provider permissions; and
responsive to determining that the service provider identified by the access token is associated with the second service provider permissions, permitting the action to be completed with respect to the second cloud resource.

3. The method of claim 2, wherein the service provider is associated with a first tenant of the cloud services platform, wherein the first customer is associated with a second tenant of the cloud services platform, and wherein the second customer is associated with a third tenant of the cloud services platform.

4. The method of claim 2, wherein the first template and the second template are published to an online marketplace by the service provider and are selectable for deployment by at least one of the first customer or the second customer.

5. The method of claim 2, further comprising:
providing a user interface via which the service provider is enabled to manage the first cloud resource allocated to the environment of the first customer and the second cloud resource allocated to the environment of the second customer; and
receiving an input from the service provider via the user interface that causes a same action to be performed with respect to the first cloud resource and the second cloud resource.

6. The method of claim 2, wherein at least the first cloud resource or the second cloud resource comprises one or more of:
a virtual machine;
a Platform-as-a-Service (PaaS) application;
a Software-as-a-Service (SaaS) application;
a storage account;
a Web application,
a database; or
a virtual network.

7. The method of claim 1, further comprising:
providing the service provider a limited duration of time to perform the action, the limited duration of time being specified by the first customer via the first template.

8. The method of claim 1, wherein the access token is provided to the service provider responsive to the service provider logging into an environment associated with the service provider.

9. The method of claim 1, further comprising:
logging the action in an activity log that is accessible to both the service provider and the first customer.

10. A system, comprising:
at least one processor circuit; and
at least one memory that stores program code configured to be executed by the at least one processor circuit, the program code comprising:
a cloud resource manager of a cloud services platform configured to:
determine that a first customer of the cloud services platform has deployed a first template published by a service provider to an environment of the first customer, the first template specifying first service provider permissions for a first cloud resource allocated to the environment of the first customer;
responsive to determining that the first customer of the cloud services platform has deployed the first template, associate an identifier of the service provider with the first cloud resource, the association indicating that the first customer has allowed the service provider to manage the first cloud resource;
receive a first request to perform an action with respect to the first cloud resource, the first request comprising an access token that comprises the identifier of the service provider;
determine whether the service provider identified by the access token is associated with the first service provider permissions; and
responsive to determining that the service provider identified by the access token is associated with the first service provider permissions, permit the action to be completed with respect to the first cloud resource.

11. The system of claim 10, wherein the cloud resource manager is further configured to:
determine that a second customer of the cloud services platform has deployed a second template published by the service provider to an environment of the second customer, the second template specifying second service provider permissions for a second cloud resource allocated to the environment of the second customer;
responsive to determining that the second customer of the cloud services platform has deployed the second template, associate the identifier of the service provider with the second cloud resource, the association indicating that the second customer has allowed the service provider to manage the second cloud resource;
receive a second request to perform an action with respect to the second cloud resource, the second request comprising the access token that comprises the identifier of the service provider;
determine whether the service provider identified by the access token is associated with the second service provider permissions; and
responsive to determining that the service provider identified by the access token is associated with the second service provider permissions, permit the action to be completed with respect to the second cloud resource.

12. The system of claim 11, wherein the service provider is associated with a first tenant of the cloud services platform, wherein the first customer is associated with a second tenant of the cloud services platform, and wherein the second customer is associated with a third tenant of the cloud services platform.

13. The system of claim 11, wherein the first template and the second template are published to an online marketplace by the service provider and are selectable for deployment by at least one of the first customer or the second customer.

14. The system of claim 11, wherein the cloud resource manager is further configured to:
provide a user interface via which the service provider is enabled to manage the first cloud resource allocated to the environment of the first customer and the second cloud resource allocated to the environment of the second customer; and
receive an input from the service provider via the user interface that causes a same action to be performed with respect to the first cloud resource and the second cloud resource.

15. The system of claim 11, wherein at least the first cloud resource or the second cloud resource comprises one or more of:
a virtual machine;
a Platform-as-a-Service (PaaS) application;
a Software-as-a-Service (SaaS) application;
a storage account;
a Web application,
a database; or
a virtual network.

16. The system of claim 10, wherein the cloud resource manager is further configured to:
provide the service provider a limited duration of time to perform the action, the limited duration of time being specified by the first customer via the first template.

17. The system of claim 10, wherein the access token is provided to the service provider responsive to the service provider logging into an environment associated with the service provider.

18. The system of claim 10, wherein the cloud resource manager is further configured to:
log the action in an activity log that is accessible to both the service provider and the first customer.

19. A computer-implemented system for managing cloud resources of a cloud services platform, comprising:
a first user interface (UI) that enables a first customer to deploy a first template published by a service provider, the deployment of the first template causing a first cloud resource deployed to an environment of the first customer to be manageable by the service provider;
a second UI that enables a second customer to deploy a second template published by the service provider, the deployment of the second template causing a second cloud resource deployed to an environment of the second customer to be manageable by the service provider; and
a third UI that enables the service provider to take actions with respect to both the first cloud resource and the second cloud resource via a single input.

20. The system of claim 19, wherein the actions comprise one or more of:
updating the first cloud resource and the second cloud resource;
reading the first cloud resource and the second cloud resource;
deleting the first cloud resource and the second cloud resource;
performing a security-related task with respect to the first cloud resource and the second cloud resource; or
performing a maintenance-related task with respect to the first cloud resource and the second cloud resource.
